(19) United States
(12) Patent Application Publication
(10) Pub. No.: US 2020/0373769 A1
(43) Pub. Date: Nov. 26, 2020

(54) CHARGING SPOT THAT HANDLES POWER OF PORTABLE POWER SUPPLY DEVICE

(71) Applicant: HONDA MOTOR CO., LTD., Tokyo (JP)

(72) Inventors: Sho Takada, Wako-shi (JP); Nobuyuki Sasaki, Wako-shi (JP); Mitsuhiro Ito, Wako-shi (JP); Mio Oshima, Wako-shi (JP); Yoshihiro Matsunaga, Wako-shi (JP); Ryo Oshima, Wako-shi (JP)

(73) Assignee: HONDA MOTOR CO., LTD., Tokyo (JP)

(21) Appl. No.: 16/991,321

(22) Filed: Aug. 12, 2020

Related U.S. Application Data
(63) Continuation of application No. PCT/JP2018/035855, filed on Sep. 27, 2018.

(30) Foreign Application Priority Data
Feb. 19, 2018 (JP) 2018-027213

(51) Int. Cl. H02J 7/00; G06Q 20/18; G06Q 50/08

(52) U.S. Cl. CPC H02J 7/00034; G06Q 50/08; G06Q 20/18; H02J 7/0047

(57) ABSTRACT

A charging spot obtains identification of a first power supply device, receives power stored in the first power supply device, and stores the power. The spot applies to the identification a compensation obtained based on an amount of the power and a purchase coefficient. The spot supplies to a second power supply device power stored in the spot, and bills for a compensation obtained based on an amount of power supplied to the second power supply device and a sales coefficient. The purchase coefficient and the sales coefficient are coefficients that are larger the higher the altitude of the spot is or that are larger the further the location of the charging spot is from a commercial AC power supply.

### CROSS-REFERENCE TO RELATED APPLICATION(S)

This application is a continuation of International Patent Application No. PCT/JP2018/035855 filed on Sep. 27, 2018, which claims priority to and the benefit of Japanese Patent Application No. 2018-027213 filed on Feb. 19, 2018, the entire disclosure of which are incorporated herein by reference.

### BACKGROUND OF THE INVENTION

### Field of the Invention

The present invention relates to a charging spot that handles the power of a portable power supply device.

### Description of the Related Art

In a commercial AC power supply network, electric power generated by a large-scale power plant is transmitted to each household or business place through a transmission network. Japanese Patent Laid-Open No. 2013-21798 proposed to provide a power management system for managing units and incentives for distributing excess power in a situation in which it is necessary to cope with excess power accompanying an increase in power generation units at the consumer side, such as in the case of large-scale utilization of a distributed power supply. Japanese Patent Laid-Open No. 2017-211947 proposed a power management device, a power system, a consumer device, a power management method, and a power management program capable of effectively utilizing surplus power to enhance the economical effect of power saving.

Japanese Patent Laid-Open No. 2013-21798 and Japanese Patent Laid-Open No. 2017-211947 are inventions relating to a commercial AC power supply network, but there are regions in which commercial AC power supply networks have not become widespread. For example, commercial AC power supply networks may not reach U.S. campgrounds. Therefore, it is thought that engine-driven generators and portable storage batteries will become more popular in the future. Portable storage batteries may comprise a battery, an inverter, or the like. Camping enthusiasts bring engine-driven generators to use home appliances at campgrounds. Here, the engine-driven generator also has a storage battery, and charges the storage battery with generated power, and supplies the power of the storage battery to an electric appliance. For example, the storage battery may be charged by a generator during the daytime when noise is less likely to occur, and power may be supplied from the storage battery to the appliance during the nighttime. Here, power charged in the storage battery may be left over. It would be convenient for a user if the user could sell this excess power. Therefore, the present invention makes it possible to sell the power stored in the portable power supply device for compensation.

### SUMMARY OF THE INVENTION

The present invention provides a charging spot operable to connect with a portable first power supply device and second power supply device, that each are for supplying power to a load. The charging spot may comprising the following elements. An acquisition unit obtains identification information of the first power supply device. A first connection unit connects to the first power supply device and receive power stored in a storage battery of the first power supply device. A power storage unit stores power received through the first connection unit. An application unit applies to the identification information of the first power supply device a compensation obtained based on an amount of power received through the first power supply device and a purchase coefficient that is associated with the charging spot and that is determined in accordance with a geographical location at which the charging spot is installed. A second connection unit connects to the second power supply device. A supply unit supplies to the storage battery of the second power supply device power stored in the power storage unit. A second measurement unit measures a power supply amount is an amount of power supplied to the second power supply device. A billing unit bills for a compensation obtained based on an amount of power supplied to the second power supply device and a sales coefficient associated with the geographical location of the charging spot. The purchase coefficient and the sales coefficient are coefficients that are larger the higher the altitude of the charging spot is or that are larger the further the location of the charging spot is from a commercial AC power supply.

### BRIEF DESCRIPTION OF THE DRAWINGS

FIG. 1 is a view illustrating a power supply system.

FIG. 2 is a view illustrating a power supply device.

FIG. 3 is a view illustrating a power supply device.

FIG. 4 is a view illustrating a charging spot.

FIG. 5 is a view illustrating a charging spot.

FIG. 6 is a view illustrating a server.

FIG. 7 is a flowchart illustrating a method that is executed by the charging spot.

FIG. 8 is a flowchart illustrating a method that is executed by the charging spot.

FIG. 9 is a flowchart illustrating a method that is executed by the server.

FIG. 10 is a view for describing a user database.

FIG. 11 is a flowchart illustrating a method that is executed by the server.

FIG. 12 is a view for describing a charging spot database.

### DESCRIPTION OF THE EMBODIMENTS

Hereinafter, embodiments will be described in detail with reference to the attached drawings. Note that the following embodiments are not intended to limit the scope of the claimed invention, and limitation is not made to an invention that requires all combinations of features described in the embodiments. Two or more of the multiple features described in the embodiments may be combined as appropriate. Furthermore, the same reference numerals are given to the same or similar configurations, and redundant description thereof is omitted.

<Power Supply System>

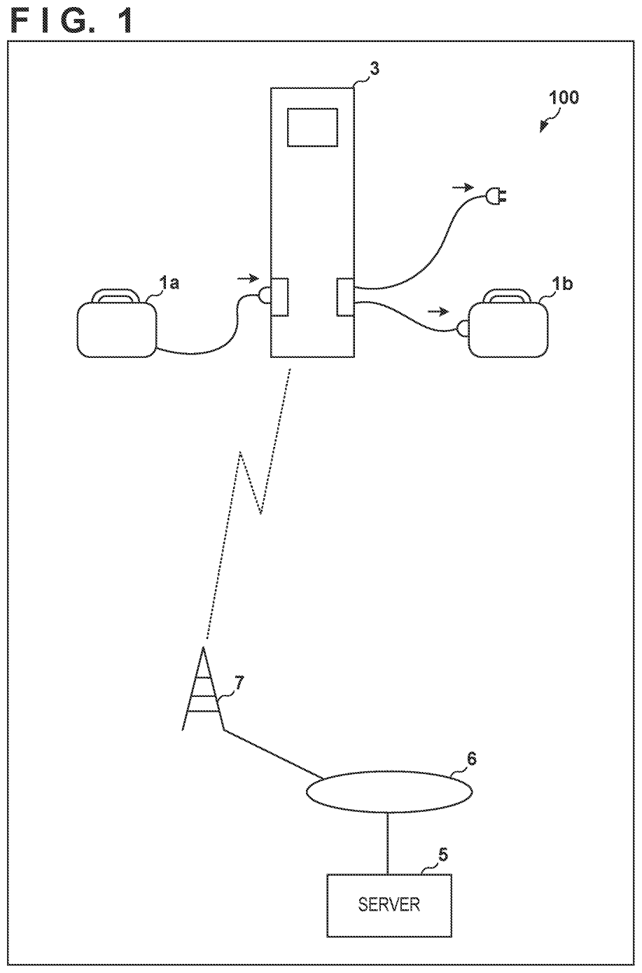

FIG. 1 illustrates a power supply system 100 having power supply devices 1a and 1b and a charging spot 3. A lowercase alphabet letter appended to the end of the reference numeral is to distinguish between identical or similar devices. Such an alphabet letter is omitted when a matter common to a plurality of devices is described. Engine-driven portable generators and portable storage batteries, which are examples of the power supply devices 1a and 1b, are utilized at construction sites and recreational facilities where commercial AC power supply networks are not widespread. Even in areas where commercial AC power supply networks are widespread, portable generators and portable storage batteries will still be used in the event of a disaster. A portable generator has a storage battery to store excess power. For example, there are cases in which a camping enthusiast has charged a storage battery of a portable generator at a campground, but does not use all of the electric power charged to the storage battery at the campground. The storage battery discharges to some extent naturally. When excess power is discharged naturally, the fuel used for power generation is wasted. Thus, in the following embodiments, a charging spot 3 that receives excess power from a user is provided.

The charging spot 3 may be installed at campgrounds, stations on the street, highway service areas, gas stations, convenience stores, parking lots, parks, shopping malls, disaster evacuation sites, and the like. The charging spot 3 connects to the power supply devices 1a and 1b via a power cable and receives power therefrom or supplies power thereto. In other words, the charging spot 3 purchases excess power from the power supply devices 1a and 1b. The user can sell off excess power. Also, the charging spot 3 sells power to the power supply devices 1a and 1b. That is, the user can purchase power from the charging spot 3.

A server 5 is a computer provided inside the charging spot 3 or outside the charging spot 3. In the case illustrated in FIG. 1, the server 5 communicates with the charging spot 3 via a network 6 and a radio base station 7. The server 5 manages user identification information and account information for the power supply devices 1a and 1b, a user-purchased power amount (spot-sold power amount), a user-sold power amount (a spot-purchased power amount), and the billing coefficient (purchase coefficient and sales coefficient) for each charging spot 3. Thus the power purchased by the user from the charging spot 3 is referred to as “user-purchased power”. Thus the power sold by the user from the charging spot 3 is referred to as “user-sold power”. The electric power purchased by the charging spot 3 from the user is referred to as “spot-purchased power”. The electric power sold by the charging spot 3 to the user is referred to as “spot-sold power”.

<Power Supply Device>

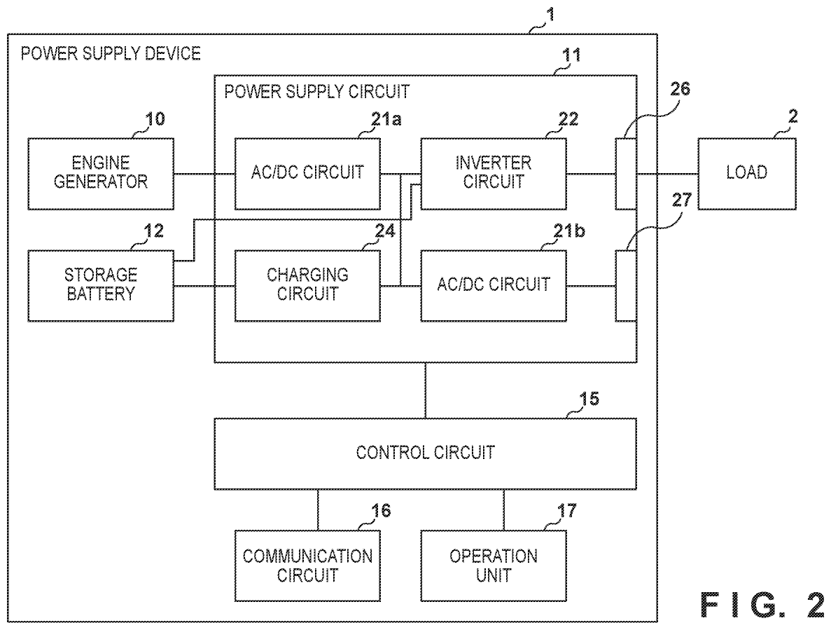

FIG. 2 is a block diagram illustrating a power supply device 1. An engine generator 10 includes an engine that operates according to fuel supplied from a fuel tank and a generator that is driven by the engine to generate electricity. The fuel may be, for example, gasoline, liquefied petroleum gas, hydrogen, or the like. A power supply circuit 11 is a circuit for converting the power generated by the engine generator 10 into a predetermined alternating current or direct current. An AC/DC circuit 21a includes a rectifying smoothing circuit for rectifying and smoothing the alternating current generated by the engine generator 10 to produce a direct current or the like. An inverter circuit 22 is a circuit for converting the direct current outputted from the AC/DC circuit 21 or a storage battery 12 into a stable alternating current of a predetermined frequency. The inverter circuit 22 may convert the direct current output from the storage battery 12 into a stable alternating current of a predetermined frequency. An AC outlet terminal 26 is a terminal to which a load 2 is to be connected. When selling the power stored in the storage battery 12 (user-sell mode), the charging spot 3 is connected to the AC outlet terminal 26. An AC inlet terminal 27 is a terminal for connecting the charging spot 3 or a commercial AC power supply. When charging the storage battery 12 by receiving a supply of power from the charging spot 3 (user-purchase mode), the AC inlet terminal 27 is connected to the charging spot 3. An AC/DC circuit 21b includes a rectifying smoothing circuit or the like for rectifying and smoothing the alternating current supplied from the AC inlet terminal 27 to produce a direct current. A charging circuit 24 charges the storage battery 12 using power input from the AC inlet terminal 27. Normally, a charging circuit 24 charges the storage battery 12 using power outputted from the AC/DC circuit 21a. A control circuit 15 is a circuit for controlling the power supply circuit 11, a communication circuit 16, an operation unit 17, or the like. The communication circuit 16 communicates with a smartphone, a personal computer (PC), the charging spot 3, the server 5, and another power supply device 1 via wired or wireless communication. The operation unit 17 includes a display device and an input device.

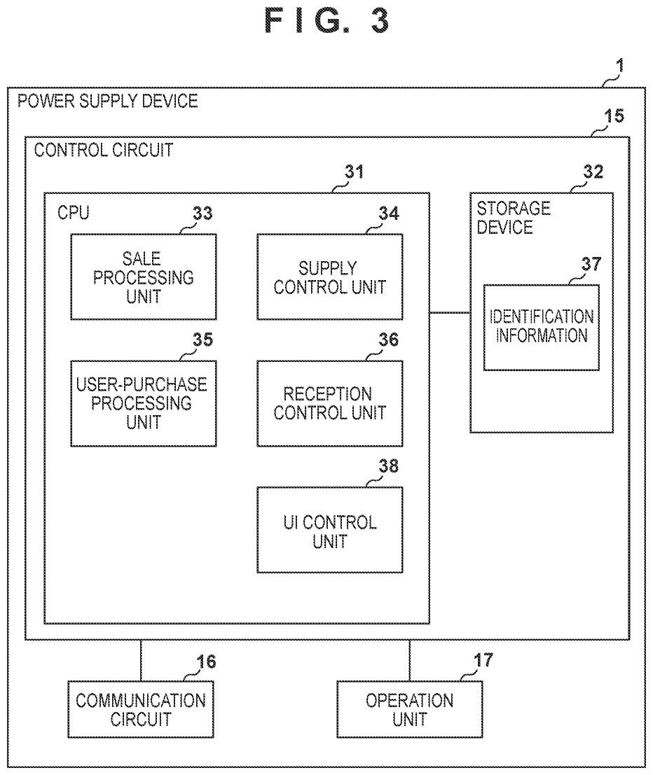

FIG. 3 is a block diagram illustrating the functions of the control circuit 15 of the power supply device 1. The control circuit 15 includes a CPU (central processing unit) 31 and a storage device 32, and the CPU 31 executes a user-sell process or a user-purchase process or the like according to a control program stored in the storage device 32. Note that some or all of the functions that the CPU 31 realizes by the control program may be implemented as hardware circuits such as an FPGA (Field Programmable Gate Array) or a DSP (Digital Signal Processor). These hardware circuits may be collectively referred to as a processor.

The storage device 32 may store identification information 37 such as a manufacturing serial number of the power supply device 1 or a user ID of a user of the power supply device 1. When a user-sell instruction (a sell power instruction) is inputted from the operation unit 17, a user-sell processing unit 33 instructs a supply control unit 34 to output power. The supply control unit 34 converts the power supplied from the storage battery 12 to alternating current in the inverter circuit 22, and outputs to the charging spot 3 through the AC outlet terminal 26. When a user-purchase instruction (a buy power instruction) is inputted from the operation unit 17, a user-purchase processing unit 35 instructs a reception control unit 36 to receive power. A reception control unit 36 converts the alternating current inputted from the charging spot 3 through the AC inlet terminal 27 into direct current by the AC/DC circuit 21b, and outputs the direct current to the charging circuit 24. The charging circuit 24 charges the power supplied from the charging spot 3 to the storage battery 12. The charging circuit 24 acquires the power storage amount by monitoring the voltage of the storage battery 12, and when the power storage amount reaches the maximum amount, ends the charging. At this time, a UI control unit 38 may display a message indicating completion of charging on the display device of the operation unit 17. The UI control unit 38 may display to the operation unit 17 that the operation mode of the power supply device 1 is the user-sell mode or the user-purchase mode. The UI control unit 38 may receive a user-sell instruction, a user-purchase instruction, or the like from a communication terminal such as a smartphone connected to the communication circuit 16. The UI control unit 38 may output, to the operation unit 17 or the like, a sales result (user-sold power, compensation, or the like) or a user-purchase result (user-purchased power, billing amount, or the like) received from the server 5 or the charging spot 3 through the communication circuit 16.

<Charging Spot>

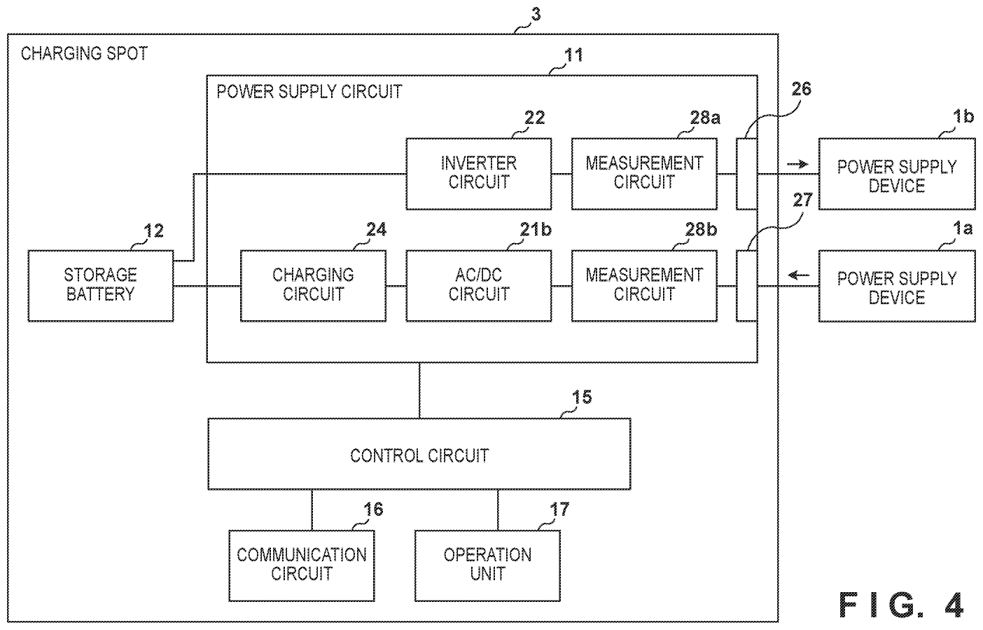

FIG. 4 is a block diagram of the charging spot 3. Of the parts of the charging spot 3, the same reference numerals are given to parts functionally similar to the parts of the power supply device 1, and the descriptions thereof are invoked thereby. As an example, the charging spot 3 purchases power from the power supply device 1a (spot-purchase mode), and the charging spot 3 sells power to the power supply device 1b (spot-sell mode). The AC outlet terminal 26 is connected to the power supply device 1b and is supplied from the storage battery 12 of the charging spot 3 to provide an alternating current generated by the inverter circuit 22 to the power supply device 1b. A measurement circuit 28a measures the total amount of power supplied to the power supply device 1b (spot-sold power amount/user-purchased power amount), and outputs the measurement result to the control circuit 15. The AC inlet terminal 27 is connected to the power supply device 1a and passes power supplied from the power supply device 1a to the AC/DC circuit 21b. The AC/DC circuit 21b converts the alternating current supplied from the power supply device 1a into direct current, and transfers the direct current to the charging circuit 24. The charging circuit 24 charges the storage battery 12 using the power supplied from the power supply device 1a. A measurement circuit 28b measures the total amount of power supplied from the power supply device 1a (spot-purchased power amount/user-sold power amount), and outputs the measurement result to the control circuit 15. The control circuit 15 communicates with the server 5, the power supply device 1a, and the power supply device 1b through the communication circuit 16.

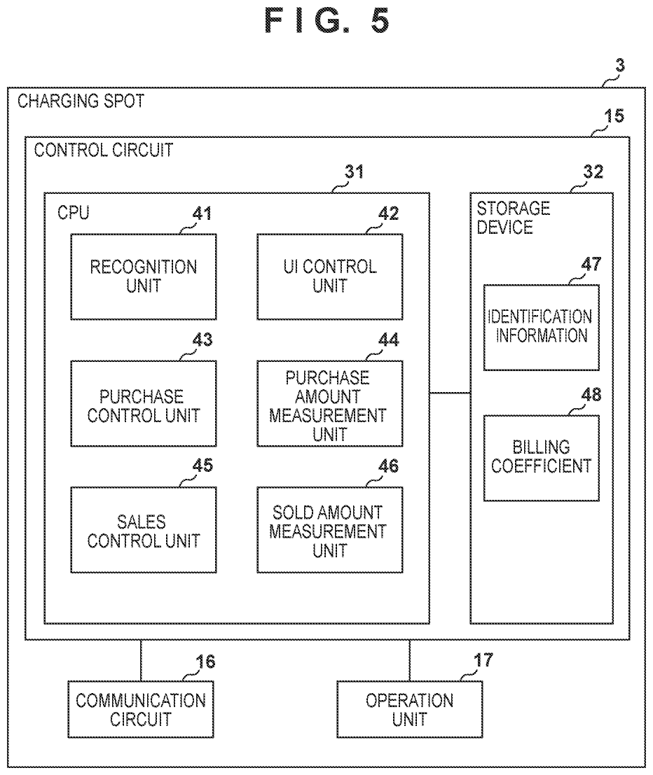

FIG. 5 is a block diagram illustrating the functions of the control circuit 15 of the charging spot 3. In FIG. 5, the same reference numerals are assigned to the same or similar functions as in FIG. 3. The control circuit 15 includes the CPU 31 and a storage device 32, and the CPU 31 executes a sell process or purchase process or the like according to a control program stored in the storage device 32. Some or all of the functions that the CPU 31 implements by the control programs may be implemented by hardware circuits such as an FPGA or a DSP. These hardware circuits may be collectively referred to as a processor.

A recognition unit 41 communicates with the power supply device 1, or based on the information input from the operation unit 17 acquires the identification information of the power supply device 1. The identification information of the power supply device 1 is a manufacturing serial number or user identification information. A UI control unit 42, to the user of the power supply device 1, outputs guidance for a selling process and the user-sale results (e.g., user-sold power amount, the amount of compensation, and the account balance) to a display device of the operation unit 17. A UI control unit 42, to the user of the power supply device 1, outputs guidance for a user-purchase process and the user-purchase result (e.g.: the user-purchased power amount, the billing amount, and the account balance) to a display device of the operation unit 17. The UI control unit 42 may communicate with the power supply device 1 or a communication terminal (e.g.: a smartphone) of the user through the communication circuit 16, and output guidance, user-sale results, user-purchase results, and the like.

A purchase control unit 43 controls the reception of power supplied from the power supply device 1 to charge the storage battery 12 or the like. A purchase amount measurement unit 44 measures the total amount of power supplied from the power supply device 1 (spot-purchased power amount), using the measurement circuit 28b. The spot-purchased power amount of the charging spot 3 and the user-sold power amount of the user will match.

A spot-sales control unit 45 controls such supply of power from the storage battery 12 to the power supply device 1. A sold amount measurement unit 46 measures the total amount of power (spot-sold power amount) supplied from the storage battery 12 to the power supply device 1, using the measurement circuit 28a. The spot-sold power amount of the charging spot 3 and the user-purchased power amount of the user will match.

The storage device 32 may store identification information 47 of the charging spot 3, a billing coefficient 48, and the like. The identification information 47 is identification information unique to each charging spot 3. The identification information 47 may include information (e.g., address (latitude and longitude), altitude, etc.) indicating the geographical location where the charging spot 3 is installed. The charging spot 3 may have a GPS (Global Positioning System) receiver for positioning latitude and longitude and an altitude sensor for measuring altitude. The billing coefficient 48 may include a purchase coefficient and a sales coefficient. For example, the farther away the location of the charging spot 3 is from a commercial AC power supply network, the greater the purchase coefficient and sales coefficient become. Further, the higher the altitude of the charging spot 3, the larger the purchase coefficient and sales coefficient become. The billing coefficient 48 may be held in the server 5.

<Server>

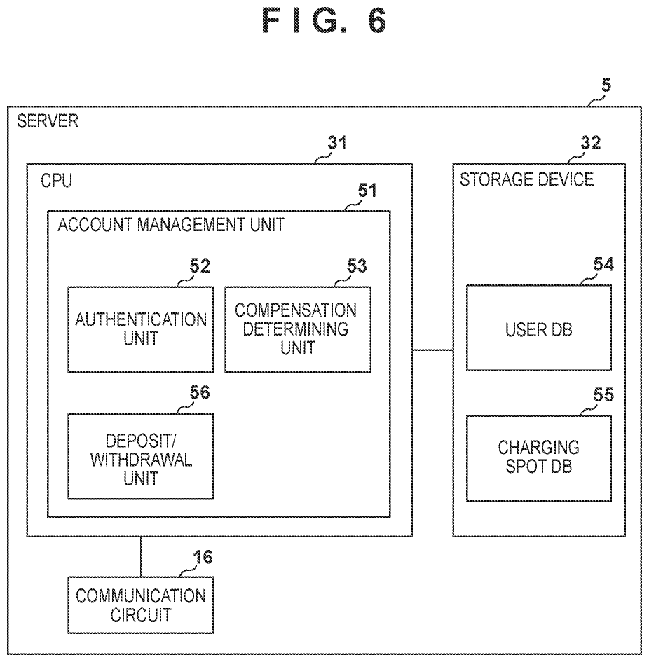

FIG. 6 is a block diagram of the server 5. Of the parts of the server 5, the same reference numerals are given to parts similar to parts of the power supply device 1 or parts of the charging spot 3.

The CPU 31 communicates with the power supply device 1 and the charging spot 3 through the communication circuit 16. The CPU 31 functions as an account management unit 51 by executing a control program stored in the storage device 32. The account management unit 51 manages the reception/supply of electric power for each user or for each power supply device 1, manages the total amount of compensation for each user or for each power supply device 1, and manages location information, a billing coefficient, and the like for each charging spot 3. An authentication unit 52 executes authentication processing for the user and the power supply device 1. For example, the authentication unit 52 determines whether the identification information of the user or the power supply device 1 received from the charging spot 3 has been registered in the user DB 54. DB is an abbreviation for database. A compensation determining unit 53 multiplies the spot-purchased power amount or the spot-sold power amount received from the charging spot 3 by a billing coefficient to determine a compensation (purchase amount or sales amount). The compensation determining unit 53 may determine the compensation using a billing coefficient received from the charging spot 3 or a billing coefficient associated with the location information (identification information) of the charging spot 3 retrieved and extracted from a charging spot DB 55. A deposit/withdrawal unit 56 adds the compensation to the account associated with the identification information of the user or the identification information of the power supply device 1, or subtracts the compensation from the account. When the deposit (addition) or the withdrawal (subtraction) of the compensation is completed, the deposit/withdrawal unit 56 transmits the information of the compensation to the charging spot 3. Some or all of the account management unit 51 may be implemented by hardware circuits such as an FPGA or a DSP.

<Flowchart>
Purchase Processing of Charging Spot (Reception Processing)

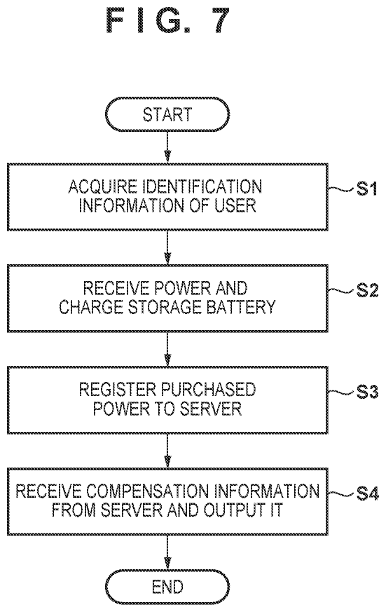

FIG. 7 is a flowchart illustrating a method by which the charging spot 3 executes purchasing and receiving of power from the power supply device 1a.
the CPU 31 of the charging spot 3 in step S1 (recognition unit 41) acquires identification information of the user. For example, the recognition unit 41 communicates with the power supply device 1a through the communication circuit 16 and receives the identification information of the user from the power supply device 1a. Alternatively, the recognition unit 41 may acquire user identification information that is inputted by the user through the operation unit 17 of the charging spot 3. Here, the user identification information may be a manufacturing serial number of the power supply device 1a.
the CPU 31 of the charging spot 3 in step S2 (purchase control unit 43) controls the power supply circuit 11 to charge the power supplied from the power supply device 1a into the storage battery 12 of the charging spot 3. Incidentally, the purchase amount measurement unit 44 uses the measurement circuit 28b, and measures the sum of the power supplied from the power supply device 1a (spot-purchased power amount). The spot-purchased power amount may also be referred to as the received amount.
In step S3, the CPU 31 (purchase amount measurement unit 44) of the charging spot 3 registers the spot-purchased power amount to the server 5. The purchase amount measurement unit 44 transmits the spot-purchased power amount, the identification information of the user, and the identification information 47 (or the billing coefficient 48) of the charging spot 3 to the server 5.
In step S4, the CPU 31 (the UI control unit 42) of the charging spot 3 receives the compensation information from the server 5, and outputs the compensation information to the display device of the operation unit 17.

Sell Processing of Charging Spot (Supplying Process)

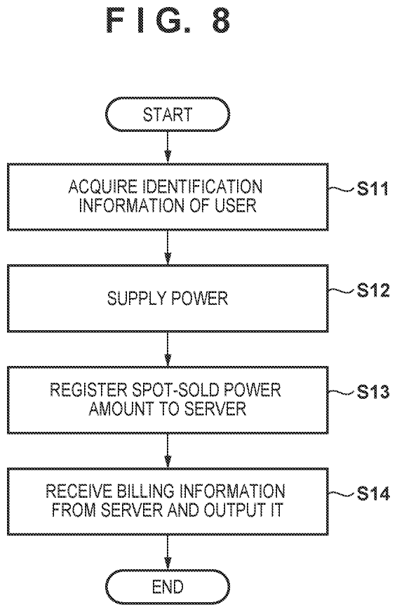

FIG. 8 is a flowchart illustrating a power supply method that the charging spot 3 executes to supply power from the power supply device 1b.
the CPU 31 of the charging spot 3 in step S11 (recognition unit 41) acquires the identification information of the user. For example, the recognition unit 41 communicates with the power supply device 1a through the communication circuit 16 and receives the identification information of the user from the power supply device 1a. Alternatively, the recognition unit 41 may acquire user identification information inputted by the user through the operation unit 17 of the charging spot 3. Here, the user identification information may be a manufacturing serial number of the power supply device 1a.
the CPU 31 (the spot-sales control unit 45) of the charging spot 3 in step S12 controls the power supply circuit 11 so as to supply the power stored in the storage battery 12 of the charging spot 3 to the power supply device 1b. Incidentally, the sold amount measurement unit 46 uses the measurement circuit 28a, and measures the total value of the power supplied to the power supply device 1b (spot-sold power amount). The spot-sold power amount may also be referred to as the supply amount.
In step S13, the CPU 31 (the sold amount measurement unit 46) of the charging spot 3 registers the spot-sold power amount to the server 5. The sold amount measurement unit 46 transmits the spot-sold power amount, the identification information of the user, and the identification information 47 (or the billing coefficient 48) of the charging spot 3 to the server 5.
In step S14, the CPU 31 (the UI control unit 42) of the charging spot 3 receives the billing information from the server 5, and outputs the billing information to the display device of the operation unit 17.

Electric Power Purchasing Process of the Server 5

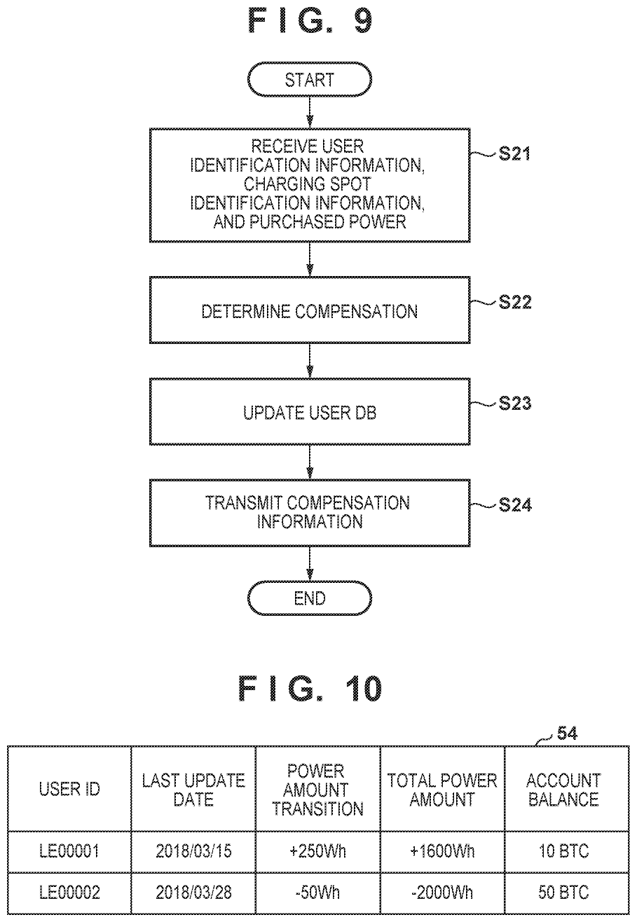

FIG. 9 is a flowchart for illustrating an account management method that the server 5 executes when the charging spot 3 purchases power from the power supply device 1a.
In step S21, the CPU 31 of the server 5 (the authentication unit 52) receives the identification information of the user, the identification information of the charging spot 3 (or the billing coefficient), and the spot-purchased power amount from the charging spot 3 of the power supply device 1a through the communication circuit 16.
In step S22, the CPU 31 (the compensation determining unit 53) of the server 5 determines the compensation relative to the spot-purchased power amount. For example, the compensation determining unit 53 reads out the billing coefficient (purchase unit price) stored in the charging spot DB 55 based on the identification information of the charging spot 3, and multiplies the billing coefficient with the spot-purchased power amount to determine the compensation. Incidentally, when a billing coefficient is received from the charging spot 3, that billing coefficient is used.
In step S23, the CPU 31 of the server 5 (the deposit/withdrawal unit 56) updates the user DB 54.

FIG. 10 illustrates an example of the user DB 54. The user ID is identification information of the user or identification information of the power supply device 1. The last update date indicates the day when the record was updated for each user. The power amount transition indicates the spot-purchased power amount (user-sold power amount) registered in the last update date or the spot-sold power amount (user-purchased power amount). The plus symbol given here to the power amount means that power has been supplied from the power supply device 1 to the charging spot 3. The minus symbol given to the power amount means that power has been supplied from the charging spot 3 to the power supply device 1. The total power amount is a total value of the spot-purchased power amount and the spot-sold power amount for each user. The account balance is the sum of the compensation received by the user minus the sum of the compensation paid by the user. The account balance may be cash, virtual currency, or points. In other words, the account may be an account from which the compensation can be withdrawn or to which a money transfer of the compensation can be made, such as a bank account, a credit account, a virtual currency account, a point account. Points are credits that can be exchanged for goods and services, discount coupons, gift certificates, or the like.

The deposit/withdrawal unit 56 identifies a record of a user held in the user DB 54 based on the user's identification information, writes the received amount to the power transition (the supplied amount from the perspective of the user), adds the received amount to the total power amount, and reflects the compensation to the account balance.
In step S24, the CPU 31 (the deposit/withdrawal unit 56) of the server 5 transmits the compensation information to the charging spot 3. The compensation information may include the most recent record of a user registered in the user DB 54.

Electric Power Selling Process of the Server 5

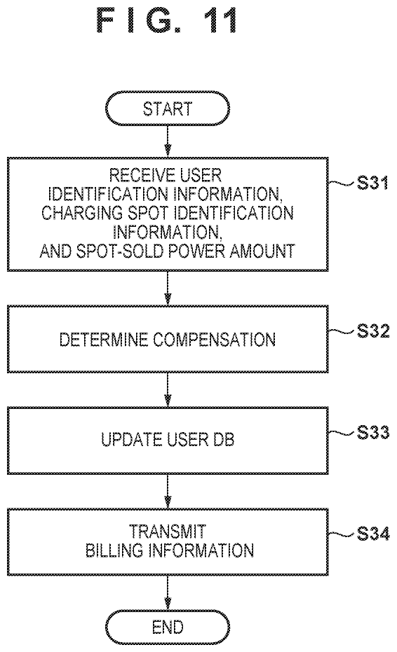

FIG. 11 is a flowchart illustrating an account management method executed by the server 5 when the charging spot 3 supplies power to the power supply device 1b.
In step S31, the CPU 31 of the server 5 (the authentication unit 52) receives through the communication circuit 16 from the charging spot 3 the identification information of the user of the power supply device 1b, the identification information of the charging spot 3 (or the billing coefficient), and the spot-sold power amount (the user-purchase amount from the perspective of the power supply device 1b).
In step S32, the CPU 31 (the compensation determining unit 53) of the server 5 determines the compensation (billing amount) relative to the spot-sold power amount. For example, the compensation determining unit 53 reads out the billing coefficient (sale unit price) stored in the charging spot DB 55 based on the identification information of the charging spot 3, and multiplies the billing coefficient with the spot-sold power amount to determine the compensation. Incidentally, when a billing coefficient is received from the charging spot 3, that billing coefficient is used.
In step S33, the CPU 31 of the server 5 (the deposit/withdrawal unit 56) updates the user DB 54. The deposit/withdrawal unit 56 identifies a record of a user held in the user DB 54 based on the user's identification information, writes the spot-sold power amount (the user-purchased power amount from the perspective of the user) to the power transition, subtracts the spot-sold power amount from the total power amount, and reflects the compensation to the account balance.
In step S34, the CPU 31 (the deposit/withdrawal unit 56) of the server 5 transmits the compensation information (billing information) to the charging spot 3. The compensation information may include the most recent record of the user registered in the user DB 54.

Charging Spot Database

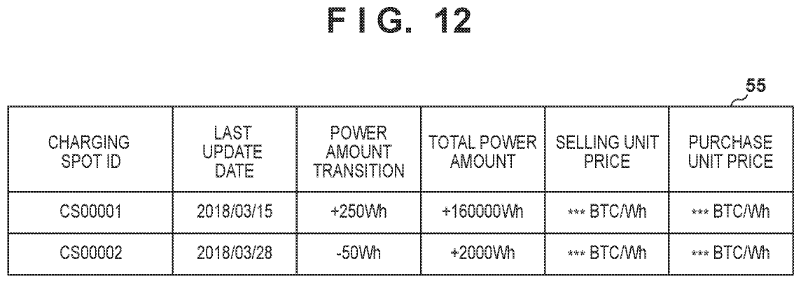

FIG. 12 illustrates an example of the charging spot DB 55. The charging spot DB 55 is provided with a record for each charging spot. The charging spot ID is identification information unique to each charging spot 3. The last update date indicates the day when the record was updated last. The power amount transition indicates the user-sold power amount or the user-purchased power amount registered on the last update date. The plus symbol given here to the power amount means that power has been supplied from the power supply device 1 to the charging spot 3. The minus symbol given to the power amount means that power has been supplied from the charging spot 3 to the power supply device 1. The total power amount is a total value of the spot-purchased power amount and the spot-sold power amount for each charging spot 3. The sales unit price is a unit price when the charging spot 3 sells electric power to the power supply device 1. The purchase unit price is a unit price when the charging spot 3 purchases electric power to the power supply device 1.

### SUMMARY

According to a first aspect, the charging spot 3 is an example of a charging spot that can connect with a portable first power supply device and second power supply device, that each supply power to a load. The power supply devices 1a and 1b are examples of the first power supply device and the second power supply device. The recognition unit 41, the communication circuit 16, or the operation unit 17 of the charging spot 3 is an example of an acquisition unit for acquiring the identification information of the first power supply device. The AC inlet terminal 27 of the charging spot 3 is an example of a first connection unit that is for connecting to the first power supply device and for receiving power stored in the storage battery of the first power supply device. The storage battery 12 of the charging spot 3 is an example of a power storage unit for storing power received through the first connection unit. The purchase control unit 43 and the purchase amount measurement unit 44 are an example of an application unit that applies, in relation to the identification information of the first power supply device, a compensation corresponding to an amount of power received through the first power supply device. By virtue of the first aspect, it becomes possible to sell the power stored in a portable power supply device for compensation.

According to a second aspect, the measurement circuit 28b and the purchase amount measurement unit 44 are an example of a first measurement unit for measuring the power reception amount (the spot-purchased power amount) is the amount of power received through the first power supply device. The communication circuit 16 of the charging spot 3 is an example of a communication unit that communicates with the server 5. The application unit transmits the power reception amount measured by the first measurement unit and the identification information of the first power supply device to the server by the communication unit. As a result, the application unit causes the server 5 to add the compensation corresponding to the power reception amount to an account associated with the identification information of the first power supply device.

According to a third aspect, the imparting unit may transmit location information indicating the geographical location of the charging spot 3 or a billing coefficient (purchase unit price) associated with the charging spot 3 to the server 5 together with the power reception amount and the identification information of the first power supply device.

According to a fourth aspect, the operation unit 17 of the charging spot 3 is an example of an output unit that outputs information of the compensation received from the server 5 by the communication unit. As a result, the user can easily know what the compensation is.

According to a fifth aspect, the AC outlet terminal 26 of the charging spot 3 is an example of a second connection unit that connects to the second power supply device. The inverter circuit 22 or the like is an example of a supply unit for supplying power stored in the power storage unit to the storage battery of the second power supply device. Thus, the provision of the power held by one user to another user via the charging spot 3 is facilitated.

According to a sixth aspect, the measurement circuit 28a of the charging spot 3 and the sold amount measurement unit 46 are an example of a second measurement unit for measuring a power supply amount (spot-sold power amount) which is the amount of power supplied to the second power supply device. The spot-sales control unit 45 and the sold amount measurement unit 46 are an example of a billing unit that bills for a compensation corresponding to the power supply amount (in other words, the billing unit charges for the power supply amount) by transmitting, to the server 5 by the communication unit, the identification information of the second power supply device acquired by the acquisition unit and the power supply amount.

According to a seventh aspect, the billing unit may transmit location information indicating the geographical location of the charging spot or a billing coefficient (selling unit price) associated with the charging spot 3 to the server 5 together with the power supply amount and the identification information of the second power supply device.

According to an eighth aspect, the identification information of the first power supply device may be the manufacturing serial number of the first power supply device or the identification information of the user of the first power supply device.

According to a ninth aspect, the acquisition unit may acquire the identification information of the first power supply device by communicating with the first power supply device.

According to a tenth aspect, the server 5, which manages a charging spot that can connect with a portable first power supply device and second power supply device, that each supply power to a load, is provided. The communication circuit 16 of the server 5 is an example of a communication unit that communicates with the charging spot 3. The account management unit 51 is an example of an account management unit that receives, by the communication unit, the received power amount which is the amount of power received by the charging spot from the first power supply device and the identification information of the first power supply device, and applies a compensation corresponding to the received power amount to an account associated with the identification information of the first power supply device.

According to an eleventh aspect, the account management unit may determine the compensation by applying a billing coefficient associated with the charging spot 3 (example: the unit price of the purchased power) to the received power amount.

The invention is not limited to the foregoing embodiments, and various variations/changes are possible within the spirit of the invention.

What is claimed is:

1. A charging spot operable to connect with a portable first power supply device and second power supply device, that each are for supplying power to a load, the charging spot comprising:
an acquisition unit configured to obtain identification information of the first power supply device;
a first connection unit configured to connect to the first power supply device and receive power stored in a storage battery of the first power supply device;
a power storage unit configured to store power received through the first connection unit;
an application unit configured to apply to the identification information of the first power supply device a compensation obtained based on an amount of power received through the first power supply device and a purchase coefficient that is associated with the charging spot and that is determined in accordance with a geographical location at which the charging spot is installed; and
a second connection unit configured to connect to the second power supply device;
a supply unit configured to supply to the storage battery of the second power supply device power stored in the power storage unit;
a second measurement unit configured to measure a power supply amount is an amount of power supplied to the second power supply device; and
a billing unit configured to bill for a compensation obtained based on an amount of power supplied to the second power supply device and a sales coefficient associated with the geographical location of the charging spot,
wherein
the purchase coefficient and the sales coefficient are coefficients that are larger the higher the altitude of the charging spot is or that are larger the further the location of the charging spot is from a commercial AC power supply.

2. The charging spot according to claim 1, further comprising a first measurement unit configured to measure a power reception amount which is an amount of power received through the first power supply device; and
a communication unit configured to communicate with a server,
wherein
the application unit is configured to, by transmitting the power reception amount measured by the first measurement unit and the identification information of the first power supply device to the server by the communication unit, cause the server to add a compensation corresponding to the power reception amount to an account associated with the identification information of the first power supply device.

3. The charging spot according to claim 2, wherein
the application unit is configured to transmit, to the server, location information indicating a geographic location of the charging spot or the purchase coefficient associated with the charging spot, together with the power reception amount and the identification information of the first power supply device.

4. The charging spot according to claim 2, further comprising
an output unit configured to output information of the compensation received from the server by the communication unit.

5. The charging spot according to claim 4, wherein
the output unit is configured to output the information of the compensation to a smartphone.

6. The charging spot according to claim 5, wherein
the billing unit is configured to, by transmitting identification information of the second power supply device and the power supply amount acquired by the acquisition unit to the server by the communication unit, bill for a compensation according to the power supply amount.

7. The charging spot according to claim 6, wherein
the billing unit is configured to transmit, to the server, location information indicating a geographic location of the charging spot or the sales coefficient associated with the charging spot, together with the power supply amount and the identification information of the second power supply device.

8. The charging spot according to claim 1, wherein
the identification information of the first power supply device is a manufacturing serial number of the first power supply device or identification information of a user of the first power supply device.

9. The charging spot according to claim 1, wherein
the acquisition unit is configured to acquire the identification information of the first power supply device by communicating with the first power supply device.

10. A server operable to manage a charging spot operable to connect with a portable first power supply device and second power supply device, that each are for supplying power to a load, the server comprising:
a communication unit configured to communicate with the charging spot;
an account management unit configured to receive, by the communication unit, a received power amount which is an amount of power received by the charging spot from the first power supply device, and identification information of the first power supply device, and to apply, to an account associated with the identification information of the first power supply device, a compensation for the received power amount obtained based on the received power amount and a purchase coefficient that is associated with the charging spot and that is determined in accordance with a geographical location at which the charging spot is installed,
wherein
the account management unit is configured to receive, by the communication unit, a power supply amount, which is an amount of power supplied by the charging spot to the second power supply device, and identification information of the second power supply device and to bill, to an account associated with the identification information of the second power supply device, for a compensation for the r the power supply amount obtained based on the power supply amount and a sales coefficient that is associated with the charging spot and that is determined in accordance with the geographical location at which the charging spot is installed, and
the purchase coefficient and the sales coefficient are coefficients that are larger the higher the altitude of the charging spot is or that are larger the further the location of the charging spot is from a commercial AC power supply.

11. A charging system, comprising a charging spot operable to connect with a portable first power supply device and second power supply device, that each are for supplying power to a load, and a server, the system comprising:
the charging spot comprises
an acquisition unit configured to obtain identification information of the first power supply device;
a first connection unit configured to connect to the first power supply device and receive power stored in a storage battery of the first power supply device;
a power storage unit configured to store power received through the first connection unit;
a first measurement unit configured to measure a power reception amount which is an amount of power received through the first power supply device; and
a second connection unit configured to connect to the second power supply device;
a supply unit configured to supply to the storage battery of the second power supply device power stored in the power storage unit;
a second measurement unit configured to measure a power supply amount which is an amount of power supplied to the second power supply device; and
a transmission unit configured to transmit, to the server, location information of the charging spot, a power reception amount measured by the first measurement unit, and identification information of the first power supply device, and also to transmit to the server the location information of the charging spot, the power supply amount measured by the second measurement unit, and
identification information of the second power supply device,
wherein
the server comprises:
a reception unit configured to receive location information of the charging spot, a power reception amount measured by the first measurement unit, and identification information of the first power supply device, and also to receive the location information of the charging spot, the power supply amount measured by the second measurement unit, and identification information of the second power supply device;
a storage unit configured to store a sales coefficient and a purchase coefficient associated with the location information of the charging spot; and
an account management unit configured to read the purchase coefficient associated with the location information of the charging spot from the storage unit, obtain a compensation based on the purchase coefficient and the power reception amount, and add the compensation to an account associated with the identification information of the first power supply device, and to read from the storage unit the sales coefficient associated with the location information of the charging spot, obtain a compensation based on the sales coefficient and the power supply amount, and subtract the compensation from the account associated with the identification information of the second power supply device,
wherein
the purchase coefficient and the sales coefficient are coefficients that are larger the higher the altitude of the charging spot is or that are larger the further the location of the charging spot is from a commercial AC power supply.
